(19) United States
(12) Patent Application Publication
(10) Pub. No.: US 2023/0152605 A1
(43) Pub. Date: May 18, 2023

(54) GLASSES HAVING AIR CURTAIN FUNCTION

(71) Applicant: ONBITT, Hwaseong-si, Gyeonggi-do (KR)

(72) Inventor: Choong Deuk KIM, Suwon-si, Gyeonggi-do (KR)

(21) Appl. No.: 17/798,639

(22) PCT Filed: Mar. 4, 2021
(86) PCT No.: PCT/KR2021/002647

§ 371 Date: Aug. 10, 2022

(30) Foreign Application Priority Data
Mar. 12, 2020 (KR) 10-2020-0030977

(51) Int. Cl. G02C 11/00; A62B 7/00

(52) U.S. Cl. CPC G02C 11/10; A62B 7/00

(57) ABSTRACT

A pair of glasses having an air curtain function includes an eye part in which lenses are mounted and a temple connected to a rear surface of the eye part, in which the eye part is composed of a rim that forms a frame such that lenses are mounted, and has an air channel through which air that is supplied through the temple is transferred and discharge holes through which the air transferred through the air channel is discharged, and joints that are integrally formed on rear surfaces of both ends of the rim and to which the temple is connected.

### TECHNICAL FIELD

The present disclosure relates to a pair of glasses having an air curtain function and, more particularly, a pair of glasses having an air curtain function in which air is supplied through fans installed in temples and the supplied air is sprayed down through holes formed at the lower portions of the rims, thereby preventing dirt or droplets from entering into a mouth or a nose.

### BACKGROUND ART

Modern people are always exposed to harmful substances including particular matter in normal life due to smoke of vehicles or yellow sand. This phenomenon is a resultant of industrialization that is rapidly changing, and the smoke of vehicles, the smoke from various factories, and particulate matter are threatening the health of modern people.

Further, respiratory syndromes that are rapidly increasing these days also are threatening the health of modern people. Severe Acute Respiratory Syndrome (SARS), Avian influenza (AI), Middle East Respiratory Syndrome (MERS), and COVID-19 recently generated may be representative, and such respiratory viruses transfer between people, particularly, through droplets, etc., so they are considered as severe problems.

Accordingly, consumption of masks rapidly increases and it is difficult to purchase masks. Further, since masks are disposable, substitutes that can replace masks are required, and substitutes that can prevent contagion by air or contagion by droplets and can be used for a long time are required to replace masks.

### DETAILED DESCRIPTION OF THE INVENTION

### Technical Problem

Accordingly, the present disclosure has been made in an effort to solve the problems in the related art described above and an objective of the present disclosure is to provide a pair of glasses having an air curtain function that includes fans mounted thereon and can block particles of droplets that may contain viruses except for air that is inhaled into the respiratory organs by spraying air around a mouth and a nose, which are respiratory organs, using the mounted fans.

### Solution to Problem

In order to achieve the objectives, the present disclosure provides a pair of glasses having an air curtain function that is composed of an eye part in which lenses are mounted and a temple connected to a rear surface of the eye part, in which the eye part is composed of a rim that forms a frame such that lenses are mounted, and has an air channel through which air that is supplied through the temple is transferred and discharge holes through which the air transferred through the air channel is discharged, and joints that are integrally formed on rear surfaces of both ends of the rim and to which the temple is connected; and the temple is composed of temple bodies that have connectors connected to the joints, fan units that are formed in the temple bodies, printed circuit boards that are formed at sides of the fan units and have a controller for controlling operation of the fan units, and batteries that are mounted in the bodies to supply power to the fans and the integrated printed circuits.

In the present disclosure, the joint is composed of a coupling step on which the connector of the temple is seated, and a hollow portion in which air that is supplied through the coupling step is temporarily stored, and the air channel is connected with the hollow portion, is tapered downward, and extends at the lower portion of the rim.

In the present disclosure, the discharge holes of both air channels are inclined symmetrically to each other with a mouth therebetween such that air is discharged to a nose and a mouth.

In the present disclosure, a ventilation hole formed such that air can be suctioned into the fan unit, an LED light formed at a side of the ventilation hole to show whether the fan unit operates and a charge state of the battery, and a power switch formed at a side of the LED light to apply power are formed at the temple body.

In the present disclosure, the connector is composed of an insertion step formed in multiple stages at the front of the temple, and the insertion steps are inserted in the joint and seated on the coupling step.

### Effect of the Invention

The pair of glasses having an air curtain function according to the present disclosure has an effect that it is possible to block particles of droplets that contains viruses except for air that is inhaled into the respiratory organs by spraying air around a mouth and a nose, which are respiratory organs, using the fans mounted on the pair of glasses.

Further, pair of glasses having an air curtain function according to the present disclosure has another effect as a face fan because it can supply airflow to respiratory organs.

Further, pair of glasses having an air curtain function according to the present disclosure has another effect that it is possible to prevent respiratory organs because it can block particulate matter, etc. using air.

### BRIEF DESCRIPTION OF DRAWINGS

FIG. 1 is a perspective view of a pair of glasses having an air curtain function according to the present disclosure.

FIG. 2 is a side view of the pair of glasses having an air curtain function according to the present disclosure.

FIG. 3 is a side view showing the configuration installed at a temple of pair of glasses having an air curtain function according to the present disclosure.

FIG. 4 is a perspective view of a temple of the pair of glasses having an air curtain function according to the present disclosure.

FIG. 5 is a perspective view of a connection portion of a temple that is connected to an eye part of the pair of glasses having an air curtain function according to the present disclosure.

FIG. 6 is a perspective view of an eye part of the pair of glasses having an air curtain function according to the present disclosure.

FIG. 7 is a cross-sectional view showing the connecting portion of an eye part and a temple according to the present disclosure.

FIG. 8 is a configuration view of an air channel formed in an eye part of the pair of glasses having an air curtain function according to the present disclosure.

FIG. 9 is a state view showing that air is supplied to a respiratory organ through the pair of glasses having an air curtain function according to the present disclosure.

### BEST MODE

As a best mode for implementing the present disclosure, a pair of glasses has an air curtain function that is composed of an eye part in which lenses are mounted and a temple connected to a rear surface of the eye part, in which the eye part is composed of a rim that forms a frame such that lenses are mounted, and has an air channel through which air that is supplied through the temple is transferred and discharge holes through which the air transferred through the air channel is discharged, and joints that are integrally formed on rear surfaces of both ends of the rim and to which the temple is connected; and the temple is composed of temple bodies that have connectors connected to the joints, fan units that are formed in the temple bodies, printed circuit boards that are formed at sides of the fan units and have a controller for controlling operation of the fan units, and batteries that are mounted in the bodies to supply power to the fans and the integrated printed circuits.

### Mode for Invention

Hereinafter, exemplary embodiments of the present disclosure will be described in detail with reference to the accompanying drawings. The following embodiments are provided to describe the present invention so that those skilled in the art can easily achieve the present invention and the spirit and scope of the present invention are not limited thereto.

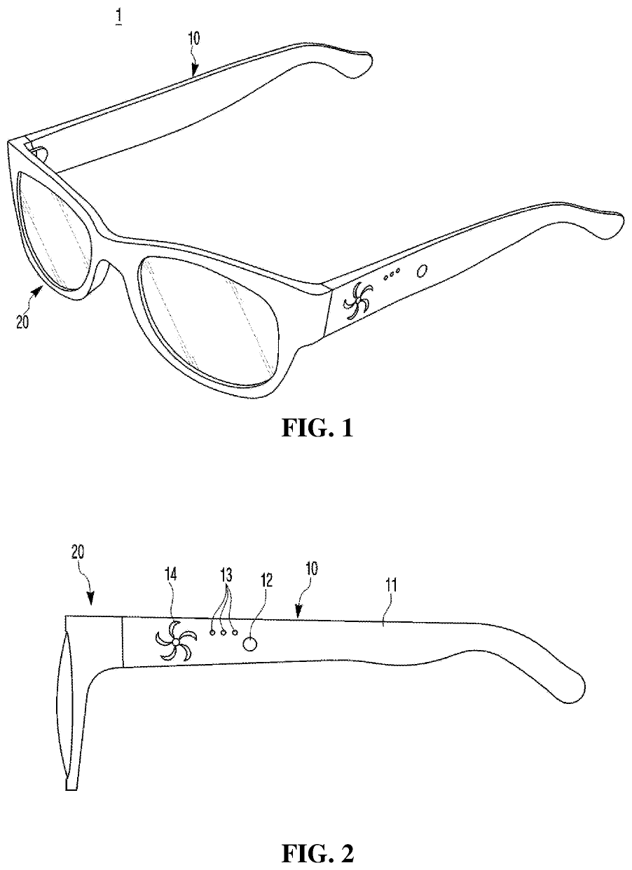

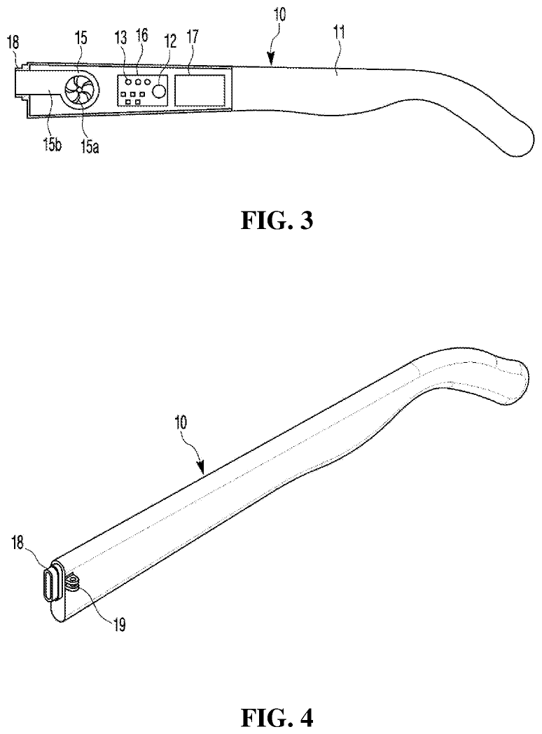

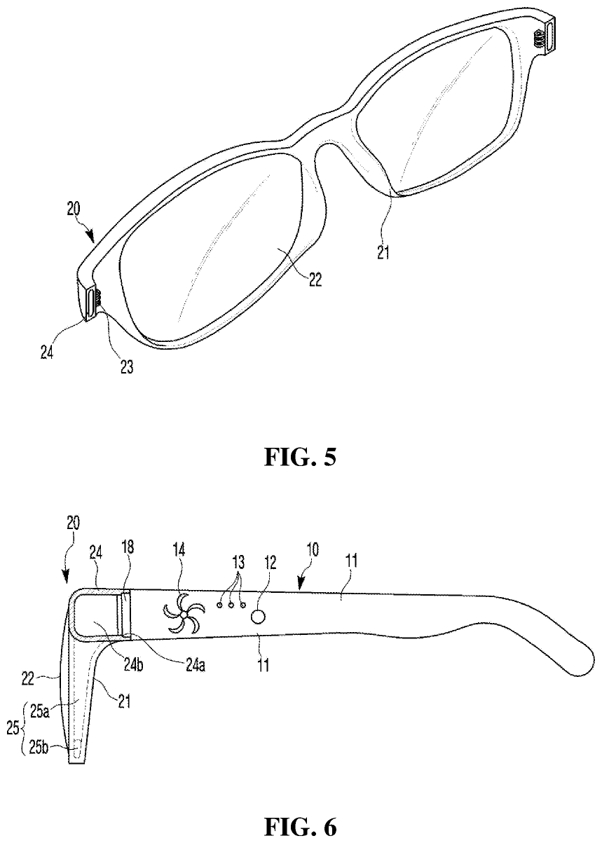

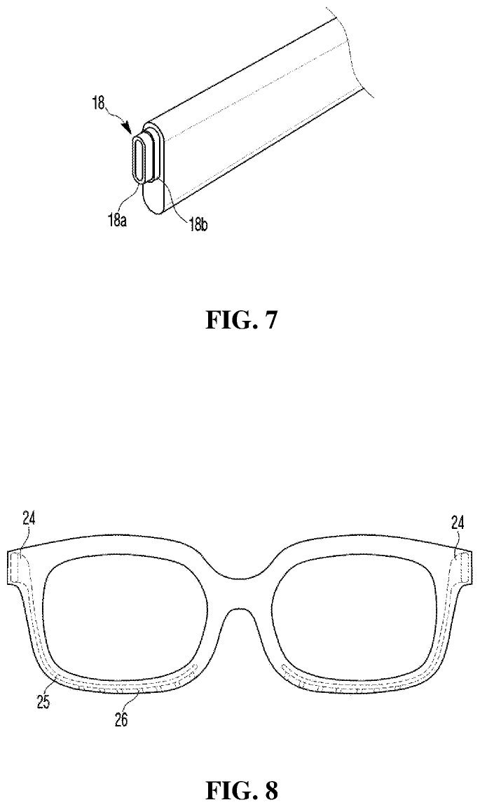

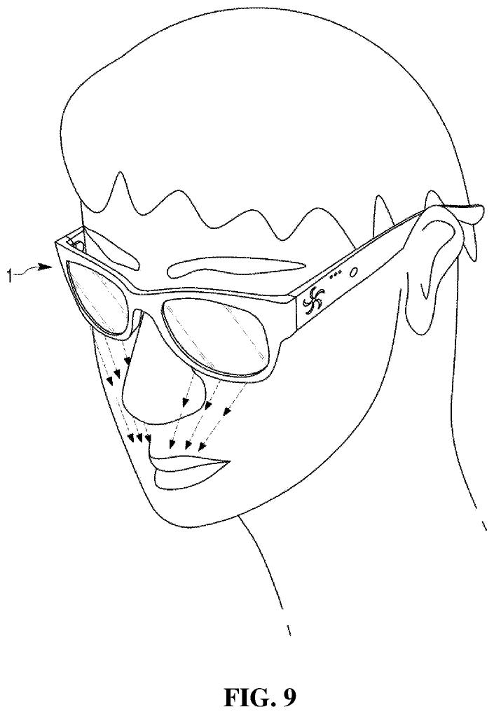

FIG. 1 is a perspective view of a pair of glasses having an air curtain function according to the present disclosure, FIG. 2 is a side view of the pair of glasses having an air curtain function according to the present disclosure, FIG. 3 is a side view showing the configuration installed at a temple of pair of glasses having an air curtain function according to the present disclosure, FIG. 4 is a perspective view of a temple of the pair of glasses having an air curtain function according to the present disclosure, FIG. 5 is a perspective view of a connection portion of a temple that is connected to an eye part of the pair of glasses having an air curtain function according to the present disclosure, FIG. 6 is a perspective view of an eye part of the pair of glasses having an air curtain function according to the present disclosure, FIG. 7 is a cross-sectional view showing the connecting portion of an eye part and a temple according to the present disclosure, FIG. 8 is a configuration view of an air channel formed in an eye part of the pair of glasses having an air curtain function according to the present disclosure, and FIG. 9 is a state view showing that air is supplied to a respiratory organ through the pair of glasses having an air curtain function according to the present disclosure.

FIG. 1 is a perspective view of a pair of glasses 1 having an air curtain function according to the present disclosure. As shown in the figure, the pair of glasses 1 having an air curtain function includes a temple 10 and an eye part 20.

A temple 10 is described in detail with reference to FIGS. 2 to 5. As shown in the figures, the temple 10 has components at a pair of temple bodies 11. The temple bodies 11 each includes a fan unit 15 mounted in the temple body 11, a printed circuit board 16 having a controller mounted at a side of the fan unit 15 to control operation of the fan unit 15, and a battery 17 mounted in the temple body 11 to supply power to the fan unit 15 and the printed circuit board 16. The temple body 11 has a ventilation hole 14 formed such that air can be suctioned into the fan unit 15, an LED light 13 formed at a side of the ventilation hole 14 to show whether the fan unit 15 operates and the charge state of the battery 17, and a power switch 12 formed at a side of the LED light 13 to apply power. The LED light 13 and the power switch 12 are attached to the printed circuit board 16 having a controller. The LED light 13 and the power switch 12 are mounted on the printed circuit board 16 to protrude from the temple body 11 or to show colors according to the LED light. The power switch 12 may be formed in a touch type and ON/OFF may be determined in accordance with the number of touches. That is, when the power switch may be driven such that it is touched one time, it is turned on, and when it is touched two times, it is turned off. When the power switch 12 is turned on, power is applied to the LED light 13, whereby whether power is supplied can be shown and how much the capacity of the battery 17 remains can be shown.

As shown in FIG. 3, the fan unit 15 includes a plurality of fans 15a and a blowing channel 15b. When the power switch 12 is pressed, the fan 15a is driven and air is suctioned to the fan 15a through the ventilation hole 14. The air suctioned to the fan 15a is sent to the blowing channel 15b by the fan 15a and transferred to the eye part 20.

FIG. 4 is a perspective view of the temple part 10 according to the present disclosure. As shown in the figure, a connector of the temple 10 is composed of multiple stages and a hinge 19 is formed at an end of the temple body 11. FIG. 5 is an enlarged view of the connector 18 of the temple 10. As shown in the figure, the connector 18 is composed of two steps of insertion steps 18a and 18b. That is, the connector 18 may be referred to as an insertion step and the insertion step 18 is composed of a front insertion step 18a and a rear insertion step 18b integrally formed with the front insertion step 18a and stepped. The connector 18 is formed such that the temple body 11 can be connected to a joint 24 of the eye part 20 and the connector 18 is fully inserted in the joint 24, whereby it is possible to prevent air from being discharged to the outside through the gap between the joint 24 and the connector 18.

FIG. 6 is a perspective view of the eye part 20 according to the present disclosure. As shown in the figure, the eye part 20 is composed of a rim 21 in which a lens 22 is fitted, a joint 24 integrally formed at both ends of the rim 21, and a corresponding hinge 23 connected to the hinge 19 to be connected with the temple body 11 and enabling the temple body 11 to rotate.

FIG. 7 shows that the connector 18 of the temple body 11 is connected to the joint 24. As shown in the figure, the insertion steps 18a and 18b of the connector 18 are seated on a coupling step 24a. The coupling step 24a is also formed in multiple stages, similar to the insertion steps 18a and 18b, whereby air is prevented from being discharged through the connector 18a inserted in the joint 24. The joint 24 is composed of the coupling step 24a and a hollow portion 24b, the hollow portion 24b forms a space expanded such that air that is transferred through the fan unit 15 of the temple body 11 can be temporarily stored. Thereafter, the air is transferred through the air channel 25 and then transferred to discharge holes 26 formed at lower portions, respectively, from the air channel 25. The air channel 25 is connected with the hollow portion 24b and is tapered downward. Since the air channel 25 is tapered downward, the air that is supplied through the fan unit 15 increases in speed and can be discharged at a high speed through the discharge holes 26. As shown in the figure, the discharge holes 26 formed at the lower portions of both rims 21 are symmetrically inclined with a mouth therebetween such that air is discharged to the nose and the mouth. Accordingly, droplets that transfer when a wearer talks or a counterpart talks can be prevented from flowing into respiratory organs such as a mouth or a nose by the airflow that is supplied downward at a high speed through the discharge holes 26.

FIG. 9 shows that airflow is discharged around the nose and mouth of a wearer by the discharge holes 26 inclined toward the respiratory system around a mouth and a nose. The discharge holes 26 are inclined to correspond to each other such that airflow is discharged around a mouth and a nose. Accordingly, there is an effect that it is possible to prevent droplets, dust, or the like from flowing inside a wearer through respiratory organs.

Although embodiments were exemplarily described above, it is apparent to those skilled in the art that the present disclosure may be implemented in various ways without departing from the spirit and scope of the present disclosure. Accordingly, the embodiments described above should be considered as being exemplary rather than limitative and all embodiments within the claims and an equivalent range would be included in the scope of the present disclosure.

1. A pair of glasses having an air curtain function that is composed of an eye part in which lenses are mounted and a temple connected to a rear surface of the eye part,
wherein the eye part is composed of a rim that forms a frame such that lenses are mounted, and has an air channel through which air that is supplied through the temple is transferred and discharge holes through which the air transferred through the air channel is discharged, and joints that are integrally formed on rear surfaces of both ends of the rim and to which the temple is connected; and
the temple is composed of temple bodies that have connectors connected to the joints, fan units that are formed in the temple bodies, printed circuit boards that are formed at sides of the fan units and have a controller for controlling operation of the fan units, and batteries that are mounted in the bodies to supply power to the fans and the integrated printed circuits.

2. The pair of glasses of claim 1, wherein the joint is composed of a coupling step on which the connector of the temple is seated, and a hollow portion in which air that is supplied through the coupling step is temporarily stored, and
the air channel is connected with the hollow portion, is tapered downward, and extends at the lower portion of the rim.

3. The pair of glasses of claim 2, wherein the discharge holes of both air channels are inclined symmetrically to each other with a mouth therebetween such that air is discharged to a nose and a mouth.

4. The pair of glasses of claim 3, wherein a ventilation hole formed such that air can be suctioned into the fan unit, an LED light formed at a side of the ventilation hole to show whether the fan unit operates and a charge state of the battery, and a power switch formed at a side of the LED light to apply power are formed at the temple body.

5. The pair of glasses of claim 4, wherein the connector is composed of a insertion step formed in multiple stages at the front of the temple, and
the insertion steps are inserted in the joint and seated on the coupling step.
